(19) United States
(12) Patent Application Publication
(10) Pub. No.: US 2019/0265010 A1
(43) Pub. Date: Aug. 29, 2019

(54) COLD-MOLDED OBJECTS AND METHODS FOR MAKING THE SAME

(71) Applicant: POWDERED BALLISTICS LLC, Glenwood, MN (US)

(72) Inventors: Leonard Greene, Glenwood, MN (US); Randy Silver, Glendwood, MN (US)

(21) Appl. No.: 16/287,573

(22) Filed: Feb. 27, 2019

Related U.S. Application Data
(60) Provisional application No. 62/636,343, filed on Feb. 28, 2018.

(51) Int. Cl. F42B 12/74; F42B 8/16; F42B 33/00; B29C 43/00; B29C 43/52

(52) U.S. Cl. CPC F42B 12/745; F42B 8/16; B29L 2031/777; B29C 43/003; B29C 43/52; F42B 33/00

(57) ABSTRACT

A method for making an object (e.g., a projectile) includes preparing a premixture of a first metal powder having a first particle size, a second metal powder having a second particle size, and a polymer binder; compressing the premixture in a mold at a pressure of about 75 psi to about 500 psi and a temperature of about 15° C. to about 40° C. to form a projectile preform; and heating the projectile preform at a temperature of about 80° C. to about 350° C. for about 0.5 minutes to about 30 minutes. The polymer binder may include a dry powder coat. The object may have a density between 1 and 4 g/cm³.

### FIELD

The present application relates to molded objects. In particular, the present application relates to molded objects (e.g., projectiles or other objects) containing a powder and a polymer binder.

### BACKGROUND

Shooting galleries may be used for target practice using various kinds of firearms. Shooting galleries of the type typically used for recreational or entertainment purposes (e.g., those found at amusement parks, fairgrounds, or carnivals) often utilize small caliber guns, such as air guns including air pistols or air rifles. Because the shooter and/or observers at such shooting galleries are typically relatively close to the target, ricocheting bullets may cause injuries to shooters and/or observers. The tendency to ricochet can be alleviated by providing a frangible bullet that disintegrates upon impact.

Alternatives to metal bullets, such as rubber bullets, are also used by law enforcement in situations where the use of firearms is needed but where it is desirable to avoid the use of lethal force. Alternatives to metal (e.g., lead or steel) bullets are also desired for use in hunting or target practice.

It would be desirable to provide a method for cold-molding objects. It would further be desirable to provide a projectile that is lead-free and cost-effective to manufacture. It would further be desirable to provide a projectile that is frangible and/or can be used as an alternative to metal bullets. It would also be desirable to provide a projectile that has good performance characteristics.

### SUMMARY

A method for making an object includes preparing a premixture of a first metal powder having a first particle size, a second metal powder having a second particle size, and a polymer binder; compressing the premixture in a mold at a pressure of about 75 psi to about 500 psi and a temperature of about 15° C. to about 40° C. to form a projectile preform; and heating the projectile preform at a temperature of about 100° C. to about 250° C. for about 0.5 minutes to about 30 minutes. The polymer binder may include a dry powder coat. The object may have a density between 1 and 4 g/cm³.

### BRIEF DESCRIPTION OF DRAWINGS

FIG. 1 is a schematic perspective view of an object according to an embodiment.

FIG. 2 is a schematic perspective view of a projectile according to an embodiment.

FIG. 3 is a process flow diagram for preparing the object of FIG. 1 according to an embodiment.

FIG. 4 is a process flow diagram for preparing the object of FIG. 1 according to an embodiment.

### DETAILED DESCRIPTION

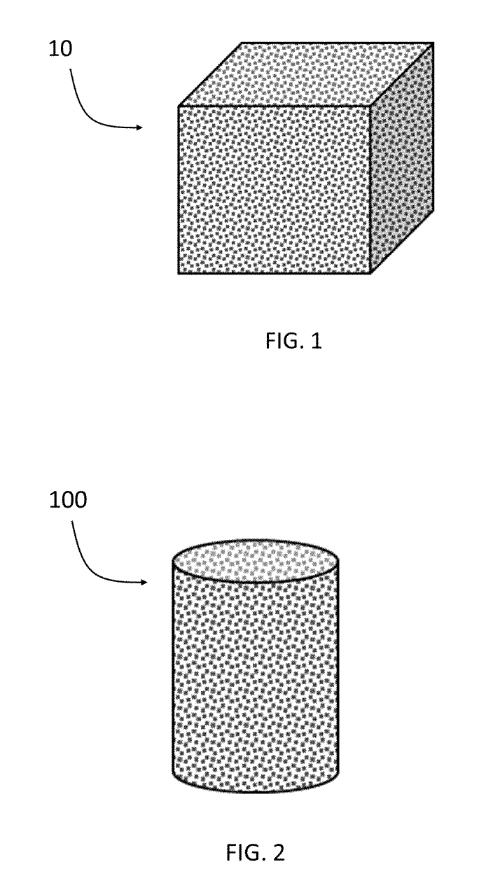

As shown in FIG. 1, the present disclosure relates to molded objects 10, such as projectiles containing a powder and a polymer binder. In an embodiment of the present disclosure, the projectile is frangible, minimizing ricochet of the projectile or its fractions from a target. In one or more embodiments, the projectile is lead-free, cost-effective to manufacture, and has performance characteristics suitable for projectiles (e.g., bullets). In certain embodiments, the projectile is suitable for use as an alternative to metal bullets, e.g., as a replacement for rubber bullets.

The term “frangible projectile” is used to describe a projectile that disintegrates into small particles upon impact with a hard surface (e.g., a target).

The term “projectile” is used in this disclosure to describe objects, e.g., bullets, pellets, shot, “BB's”, etc., intended to be launched from a discharging device, e.g., a gun, a firearm, an air gun (e.g., air rifle or air pistol), etc.

The term “particle size” is used here to refer to volume-based particle size, where the particle size is equal to the diameter of a sphere that has the same volume as the particle in question. Particle size may be determined by sieve analysis, which typically yields a particle size distribution. Particle size may also be determined by using a particle size analyzer. Particle size analyzers may be based on one of many techniques, such as light scattering, high definition imaging, Brownian motion analysis, gravitational settling, etc.

The terms “dry powder coat” and “dry powder coating material” are used here to refer to sources of polymers or polymer blends used as a binder in some embodiments of this disclosure. While such materials are typically used for dry powder coating, the term, as used here, is not intended to indicate the function of the material in the present disclosure but rather its commercially available source.

The term “caliber” is used here to refer to the size of a projectile (e.g., bullet or shot). Caliber may be given as a numeric value (e.g., .170 caliber), referring to the diameter of the projectile in inches, unless otherwise specified.

The term “about” is used here in conjunction with numeric values to include normal variations in measurements as expected by persons skilled in the art and is understood have the same meaning as “approximately” and to cover a typical margin of error, such as ±5% of the stated value.

Terms such as “a,” “an,” and “the” are not intended to refer to only a singular entity but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The phrase “substantially free” is used here to describe an amount of a substance that is not sufficient to provide the usual characteristic properties of the substance. For example, substantially free of a solvent means an amount of solvent that is not sufficient to provide solvent properties to the composition. An amount that is “substantially free” may be less than about 1%, or less than about 0.1% by weight.

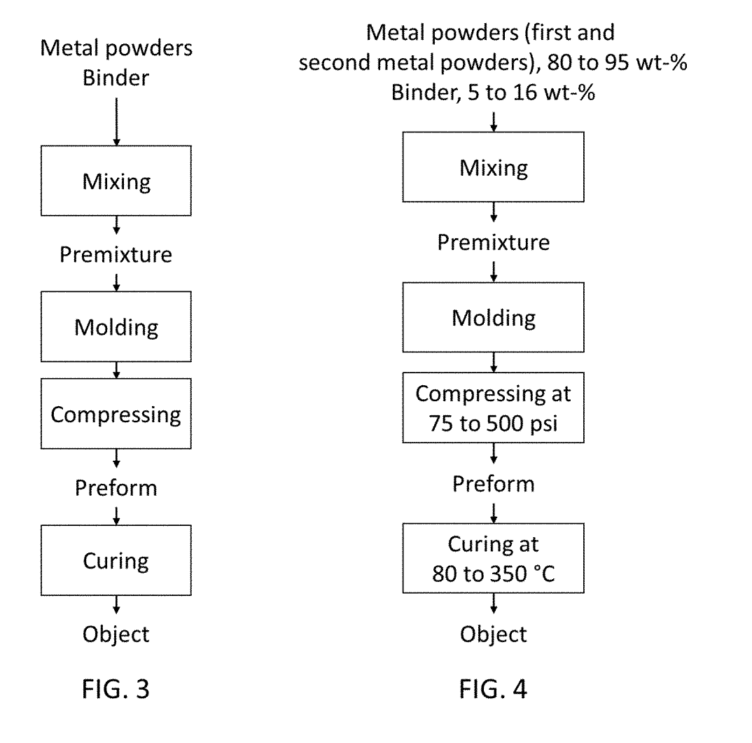

The present disclosure provides methods (e.g., FIGS. 3 and 4) for making molded objects (e.g., FIGS. 1 and 2). The methods may be useful for the manufacturing objects that can be molded and may exist in a certain range of hardness and density produced by the methods. The method is useful for making other objects that may benefit from the physical and/or chemical characteristics resulting from the method. The shape and size of the object may be any shape and size that may be produced by molding. Alternatively, the object may be formed by coupling two or more molded portions together.

In some embodiments, the method may be used for prototyping. For example, the method of the present disclosure may provide a relatively easy and cost-effective way to produce prototypes of articles that are intended to be produced in full scale production by some other, perhaps more expensive, time-consuming, or difficult method, or to be produced from more expensive raw materials.

Some examples of objects that can be made using the methods of the present disclosure include but are not limited to projectiles (e.g., frangible bullets), sporting equipment and parts therefor (e.g., fishing weights, fishing lures, fishing jigs, weighted fishing hooks, and the like), and molded prototypes, etc.

According to an embodiment and as shown in FIG. 3, the method includes preparing a premixture of a first metal powder having a first particle size, a second metal powder having a second particle size, and a polymer binder. The premixture is provided (e.g., dispensed) into a mold and compressed to form a preform. The preform is cured (e.g., heated) either before or after being removed from the mold to produce the object.

The object may optionally be finished in a finishing step, for example by smoothing any imperfections or by applying a finishing coat. A finishing coat may include any suitable coating (e.g., paint, varnish, oil, etc.) or powder coating. The object may optionally be finished or polished by a suitable technique, such as machining, rolling, sanding, tumbling in a tumbler, etc., to remove any residual protrusions or roughness due to the molding process, and/or to leave a desired surface finish. The finishing step may be used to modify (e.g., increase, decrease, or even out) the size of the object to arrive at the desired final size.

The mixing step may be performed by any suitable mixing method, using any suitable mixing equipment. For example, mixing may be performed manually or in a semi-automated or automated manner, by stirring, turning, tumbling, compounding, etc. In one embodiment, the ingredients (e.g., first and second metal powders, binder, and any optional additives or fillers) are mixed until the premixture is substantially homogenous. The mixing may be done in a container, drum, tumbler, mixer, or any other suitable device.

The molding step may be performed by any suitable molding method, using any suitable molding equipment. For example, the molding may be done in a one-piece female mold, in a two-piece female mold, or in a mold that includes one or more undercuts (e.g., male mold pieces). The premixture can be provided into the mold by any suitable method, such as pouring, dispensing, extruding, pressing, wiping, etc.

The compressing step may be performed by any suitable compressing method, using any suitable compressing equipment that is compatible with the mold. For example, the compressing may include manual or automated mechanical compression, hydraulic compression, compressed air and/or pneumatic compression, or the like. An example of a mold and press combination is a tablet press where the mold cavities are constructed to produce the desired shape and size object.

The curing step may be performed by any suitable curing method, using any suitable curing equipment. Curing is typically effected by applying a form of energy to the item to be cured. For example, the curing may include heating or application of electromagnetic radiation, such as UV radiation. The curing method and time may be selected based on the type of binder used. The curing time may also be adjusted based on the amount of energy applied, with shorter times needed when higher levels of energy are used.

In one embodiment and as shown in FIG. 4, the method includes preparing a premixture of a first metal powder having a first particle size, a second metal powder having a second particle size, and a polymer binder; applying the premixture into a mold and compressing the premixture at a pressure of about 75 psi to about 500 psi to form a preform; and heating the preform at a temperature of about 80° C. to about 350° C. to cure the preform and to form the object. In some embodiments, the compressing is performed at a temperature of about 15° C. to about 40° C. In some embodiments, the curing is performed by heating the preform at a temperature of about 100° C. to about 250° C. for about 0.5 minutes to about 10 minutes.

In some embodiments of the method shown in FIGS. 3 and 4, the pressure during compressing may be from about 75 psi to about 500 psi, from about 80 psi to about 400 psi, from about 90 psi to about 300 psi, or from about 100 psi to about 150 psi. The compressing may be done at ambient temperature, or at about 15° C. to about 40° C., or at about 17° C. to about 35° C. Some heating of the premixture in the mold may occur due to the pressure applied during compressing. However, while the mold or the premixture may be heated if desired, the compressing may be done without additional heating of the mold or the premixture within the mold.

The preform of the object may be cured (e.g., by heating) either after the preform is removed from the mold, or the curing may be done after compressing but while the preform is still within the mold. In some embodiments, the preform is removed from the mold first and then heated. The heating of the preform may cause cross linking of the polymer binder. The heating temperature and time may depend at least to some degree on the size of the preform. The preform may be heated to a temperature of at least about 80° C., at least about 100° C., at least about 120° C., or at least about 150° C. The preform may be heated up to about 350° C., up to about 320° C., up to about 300° C., up to about 275° C., or up to about 250° C. For example, the preform may be heated from about 80° C. to about 350° C., about 100° C. to about 250° C., or about 150° C. to about 200° C. The temperature may be maintained for at least about 0.5 minutes, at least about 1 minute, at least about 2 minutes, at least about 3 minutes, at least about 5 minutes, at least about 10 minutes, or at least about 20 minutes. The temperature may be maintained for up to 60 minutes, up to 45 minutes, up to 30 minutes, up to 20 minutes, up to 10 minutes, up to 6 minutes, or up to 3 minutes. For example, the temperature may be maintained for about 0.5 minutes to about 10 minutes, about 0.5 minutes to about 6 minutes, or for about 1 minute to about 3 minutes.

The method may further include coupling two or more portions to form the object. For example, surfaces of two or more portions may be pressed together. Applying pressure to the two or more portions may be sufficient to couple the portions to form the object. Alternatively or additionally, the two or more portions may be heated after or during pressing together to couple the portions. In such embodiments, the binder may include a thermoplastic component. The portions may also be coupled by using an adhesive.

The first and second metal powders, the polymer binder, and their relative amounts may be selected such that the object has desired characteristics. For example, the premixture may be prepared so that the resulting object has a desired density, which may depend on the intended use of the object. The premixture may also be prepared so that the resulting object is frangible. A frangible object disintegrates into small particles upon impact.

The object may have a density of at least about 1.0 g/cm³, at least about 1.5 g/cm³, at least about 2.0 g/cm³, at least about 2.8 g/cm³, or at least about 3.0 g/cm³. The density of the object may be up to about 4.5 g/cm³, up to about 4.0 g/cm³, up to about 3.8 g/cm³, up to about 3.5 g/cm³, up to about 3.3 g/cm³, or up to about 3.0 g/cm³. In one embodiment, the premixture is prepared so that the resulting object has density of about 1.0 g/cm³ to about 4.0 g/cm³, about 2.0 g/cm³ to about 3.9 g/cm³, about 2.8 g/cm³ to about 3.8 g/cm³, about 3.0 g/cm³ to about 3.5 g/cm³, or about 3.1 g/cm³ to about 3.3 g/cm³. For example, when the intended object is a projectile intended to be mechanically propelled by compressed gas (e.g., shot from an air gun), the premixture may be prepared so that the projectile has a density of about 3.0 g/cm³ to about 3.4 g/cm³. In one exemplary embodiment, the object (e.g., a projectile) has a density of about 3.2 g/cm³.

In some embodiments, the object is a projectile, such as a bullet, a pellet, a shot (e.g., BB shot, T shot, or another size of shot), or another form of ammunition, and the premixture is prepared to have a suitable mixture of metal powders and polymer binder, and the mold is selected accordingly.

The polymer binder may include any suitable polymers, such as thermoset plastics, thermoplastics, or combinations thereof. In some embodiments, the polymer binder includes one or more materials selected from polyesters, polyurethanes, epoxies, polyacrylates, polycarbonates, and mixtures and composites thereof. In one embodiment, the polymer binder includes polyurethane.

When preparing the premixture, the polymer binder may be mixed in as a free-flowing dry powder. For example, the polymer binder may be a dry powder coating material. Exemplary polymer binders include mixtures that are commercially available as powder coating materials. Powder coating materials typically include a polymer resin mixture and optionally curatives, pigments, leveling agents, flow modifiers, or other additives. Commercially available powder coating materials are available, for example, under the tradenames VALDE® from Valspar Corp. in Minneapolis, Minn.; TRUPEEL™ from TCI Powder Coatings in Ellaville, Ga.; CRYLCOAT® from Allnex in Frankfurt, Germany; and many others.

The polymer binder may also include other components, such as cross linkers, catalysts, fillers, pigments, and other additives. Additives may be either mixed into the polymer binder prior to mixing with the metal powder to form the premixture, or may be added into the metal powder before or simultaneously with the polymer binder, or may be added to the premixture after mixing the metal powder with the polymer binder.

In one embodiment, the additives include pigments, colorants, opacifiers, visibility aids, or combinations thereof. Examples of visibility aids include fluorescent and phosphorescent compounds. According to an embodiment, the object includes an additive such as a pigment, colorant, opacifier, visibility aid, or a combination thereof. The additive may be mixed with the binder, and may be distributed throughout the object. In one embodiment, the object is a projectile and the binder includes a colorant and/or visibility aid.

The additives may also include lubricants, sealants, processing aids, etc. One example of an additive that may provide protection against corrosion is a wax, such as a synthetic wax or natural wax.

The polymer binder is preferably free of or substantially free of solvents. For example, the polymer binder may include less than 1% solvent, less than 0.1% solvent, or no solvent.

The polymer binder may be at least partially cured prior to its use in the premixture. The term “partially cured” is used here to refer to a polymer or polymer mixture that is polymerized at least to a degree that the polymer is solid at room temperature, but is capable of further curing or cross-linking when heat or another form of energy (e.g., UV light) is applied to the material. In some embodiments the polymer binder includes partially cured polymers and is a free-flowing powder.

The ingredients of the premix may be selected to result in a suitable density for the object (e.g., projectile). For example, the types of metal powders, the particle sizes of the metal powders, and the relative amounts of metal powders and polymer binder may be selected to adjust the density of the end product.

The first and second metal powders may include any suitable metals and/or alloys. However, it may be desirable to select cost effective metals or alloys that also have a suitable density and are environmentally friendly. Suitable metals may include iron, nickel, copper, zinc, tungsten, etc., and their mixtures and alloys. The first and second metal powders may include the same metal, metal mixture, or metal alloy, or may include different metals, metal mixtures, or metal alloys. In some embodiments, the first and/or second metal powder includes iron powder. For example, at least one of the first and second metal powders may include sponge iron powder.

Sponge iron is produced by reducing finely divided iron ore to yield a spongy and highly porous mass of solid metallic iron. The spongy mass of iron can then be comminuted to produce iron powder. Sponge iron powder (also known as Swedish sponge iron powder) is commercially available, for example, from Höganäs AB in Sweden. Sponge iron powder has good compressibility and high green strength.

The metal powders may also be selected to reduce environmental issues experienced with used projectiles (e.g., used bullets, pellets, or shot). For example, the metal powders may be selected so that the object is free or substantially free of lead and/or other heavy metals.

The porosity and the particle sizes of the metal powders affect the density of the object. The particle sizes of the metal powders may be selected to adjust the amount of space between particles. The premixture may be prepared with at least a first metal powder having a first particle size, and a second metal powder having a second particle size. In some embodiments, the first particle size is different from the second particle size. For example, the first particle size may be greater (on average) than the second particle size. Additional metal powders may also be used.

The first metal powder has a first particle size (e.g., at least 90 wt-% of the particles of the first metal powder fall within the particle size range) that may be from about 0.02 mm to about 2 mm, from about 0.03 mm to about 1.5 mm, or from about 0.04 mm to about 1 mm. In one embodiment, the first particle size is from about 0.05 to about 0.9 mm.

The second metal powder has a second particle size (e.g., at least 90 wt-% of the particles of the second metal powder fall within the particle size range) that may be from about 0.001 mm to about 0.5 mm, from about 0.01 mm to about 0.3 mm, or from about 0.02 mm to about 0.2 mm. In one embodiment, the second particle size is from about 0.04 mm to about 0.15 mm.

In some embodiments, the first particle size that is greater than the second particle size by a factor of 2 or greater, 3 or greater, 4 or greater, or 5 or greater. The first particle size may be greater than the second particle size by a factor of up to 100, up to 75, up to 50, up to 25, or up to 10.

The first metal powder and the second metal powder may be present in the premixture and in the finished object (e.g., projectile) at a weight ratio of about 6:4 to about 0.1:9.9, about 6:4 to about 2:8, or about 6:4 to about 4:6. In one embodiment, the first metal powder and the second metal powder are present in the premixture at a weight ratio of about 1:1.

The weight ratio of metal powders (combined first and second metal powders) to polymer binder may vary. The premixture or the finished object may include at least 10 wt-%, at least 15 wt-%, at least 20 wt-%, at least 25 wt-%, at least 30 wt-%, at least 40 wt-%, at least 50 wt-%, at least 60 wt-%, at least 70 wt-%, at least 80 wt-%, at least 85 wt-%, or at least 88 wt-% of metal powders. The premixture or the finished object may include up to 95 wt-%, up to 94 wt-%, up to 93 wt-%, up to 92 wt-%, up to 90 wt-%, up to 89 wt-%, up to 85 wt-%, up to 80 wt-%, up to 75 wt-%, up to 50 wt-%, or up to 25 wt-% wt-% of metal powders. The amount of metal powders can be lower if the composition includes other components (e.g., fillers) with a high density (e.g., density same as, similar to, or higher than the metal powders), contributing to the overall density of the composition. The remainder of the premixture or the finished object may comprise, consist essentially of, or consist of the polymer binder.

The premixture and the finished object may contain at least about 5 wt-%, at least about 6 wt-%, at least about 7 wt-%, at least about 10 wt-%, at least about 15 wt-%, at least about 20 wt-%, at least about 25 wt-%, at least about 30 wt-%, or at least about 50 wt-% of polymer binder. The premixture and the finished object may contain up to about 98 wt-%, up to about 96 wt-%, up to about 95 wt-%, up to about 94 wt-%, up to about 92 wt-%, up to about 90 wt-%, up to about 85 wt-%, up to about 80 wt-%, up to about 75 wt-%, up to about 70 wt-%, up to about 60 wt-%, up to about 50 wt-%, up to about 40 wt-%, up to about 30 wt-%, up to about 25 wt-%, up to about 20 wt-%, up to about 16 wt-%, up to about 14 wt-%, or up to about 12 wt-% of polymer binder. The premixture and the finished object may contain about 5 wt-% to about 16 wt-%, about 6 wt-% to about 14 wt-%, or about 7 wt-% to about 12 wt-% of polymer binder. In some embodiments the premixture and the finished object contain from about 25 wt-% to about 95 wt-%, or from about 50 wt-% to about 90 wt-% of polymer binder.

The metal powder (combined first and second metal powders) and the polymer binder may be present in the premixture or the finished object at a weight ratio of about 95:5, 94:6, 93:7, 92:8, 89.5:10.5, 88:12, 85:15, 80:20, 75:25; 70:30, 60:40, 50:50, 40:60, 30:70, 25:75, 20:80, 15:85, 10:90, 8:92, 6:94, 5:95, 4:96, 3:97, or 2:98. For example, the weight ratio may range from about 95:5 to about 20:80, about 94:6 to about 50:50, about 93:7 to about 88:12, or about 92:8 to about 89.5:10.5. In one embodiment, the combined first and second metal powders and the polymer binder are present at a weight ratio of about 9:1.

In some embodiments the object includes about 80 wt-% to about 95 wt-%, about 84 wt-% to about 94 wt-%, or about 88 wt-% to about 93 wt-% of metal powders, with a weight ratio of first metal powder and second metal powder of about 6:4 to about 0.1:9.9, about 6:4 to about 2:8, or about 6:4 to about 4:6. The object may contain about 5 wt-% to about 16 wt-%, about 6 wt-% to about 14 wt-%, or about 7 wt-% to about 12 wt-% of polymer binder. The weight ratio of metal powders and the polymer binder may be about 94:6 to about 80:15, about 93:7 to about 85:12, or about 92:8 to about 89.5:10.5.

The methods described in this disclosure can be used to produce various molded objects. The mold used in the molding step may be selected to provide any desired shape and size for the object. Alternatively, the mold may be selected to provide a portion of the desired shape, and the desired shape may be formed by coupling two or more portions.

A schematic view of an object 10 according to an embodiment is shown in FIG. 1. The object 10 has a body made up of a mixture of a first metal powder having a first particle size, a second metal powder having a second particle size, and a polymer binder. The first and second metal powders may be dispersed in the polymer binder substantially evenly throughout the object 10.

In some embodiments, the object is a projectile. Exemplary projectiles include bullets, pellets, shot, etc. In one embodiment, the projectile is a bullet. In one embodiment, the projectile may be used as a replacement for rubber bullets. In another embodiment, the projectile is a pellet. In yet another embodiment, the projectile is a shot. A schematic view of a projectile 100 is shown in FIG. 2. The projectile 100 has a body made up of a mixture of a first metal powder having a first particle size, a second metal powder having a second particle size, and a polymer binder. The first and second metal powders may be dispersed in the polymer binder substantially evenly throughout the projectile 100.

Projectiles made according to the embodiments of the present disclosure may exhibit several benefits over the prior art. For example, the projectiles may provide one or more of: lead-free construction; frangibility upon impact; cost-effective manufacturing; ability to replace rubber bullets; ability to replace steel or lead shot (e.g., for use in air guns); compatibility with magnetically assisted loading systems, etc.

The mold may be selected to prepare projectiles of various sizes. For example, the projectile may be sized, or define a size, for a specific barrel size. The projectile may be sized to have a caliber of at least .103 (e.g., a projectile defining, or having, a diameter of 0.103 inches) or greater. The projectile may be sized between about .103 caliber (e.g., a projectile defining, or having, a diameter of 0.103 inches) and about .80 caliber (e.g., a projectile defining, or having, a diameter of 0.80 inches), or between about .172 caliber (e.g., a projectile defining, or having, a diameter of 0.172 inches) and about .50 caliber (e.g., a projectile defining, or having, a diameter of 0.50 inches). In one embodiment, the projectile is .175 caliber (0.175 inches in diameter). In another embodiment, the projectile is .179 caliber (0.179 inches in diameter). Further, the projectile may define a diameter that is greater than or equal to about .103 caliber, greater than or equal to about .172 caliber, greater than or equal to about .20 caliber, greater than or equal to about .224 caliber, greater than or equal to about .25 caliber, greater than or equal to about .308 caliber, greater than or equal to about .338 caliber, greater than or equal to about .40 caliber, greater than or equal to about .5 caliber, etc. and/or less than or equal to about .80 caliber, less than or equal to about .58 caliber, less than or equal to about .50 caliber, less than or equal to about .45 caliber, less than or equal to about .357 caliber, less than or equal to about .243 caliber, less than or equal to about .22 caliber, etc.

Additionally, as noted herein, the projectile may be a shot-style projectile, which may also define various specific sizes. For example, the projectile as shot may be sized between about #12 size shot (e.g., a round projectile defining, or having, a diameter of 0.05 inches) and about 0000 size shot (e.g., a round projectile defining, or having, a diameter of 0.38 inches).

In one exemplary embodiment, the projectile is .170 to .22 caliber shot (e.g., .170 to .180 caliber, also referred to as BB shot, or .20 to .21 caliber, also referred to as T shot). The projectile may be suitable for use with air guns and is compatible with magnetically assisted loading systems. The projectile may also be frangible such that ricochet problems typical of steel shot can be reduced.

In some embodiments, different size projectiles (e.g., different caliber bullets or pellets) may be color coded for easy identification of size. For example, a pellet of .172 caliber may have a first color, a pellet of .175 caliber may have a second color, and a pellet of .179 caliber may have a third color.

The mass of the projectile depends on the density of the composition used to make the projectile and the size of the projectile. In one embodiment, the projectile is a bullet with a mass of at least about 0.2 grams, at least about 0.4 grams, at least about 0.6 grams, at least about 0.8 grams, at least about 1.0 grams, at least about 1.2 grams, at least about 1.5 grams, at least about 2 grams, or at least about 3 grams. The bullet may have a mass of up to about 10 grams, up to about 5 grams, up to about 4 grams, up to about 3 grams, or up to about 2 grams. In another embodiment, the projectile is a pellet with a mass of at least about 0.1 grams, at least about 0.2 grams, at least about 0.3 grams, at least about 0.35 grams, at least about 0.4 grams, or at least about 0.5 grams. The pellet may have a mass of up to about 1 gram, up to about 0.8 grams, up to about 0.6 grams, up to about 0.5 grams, or up to about 0.4 grams. The pellet may have a mass ranging from about 0.2 grams to about 1 gram, about 0.3 grams to about 0.35 grams, about 0.35 grams to about 0.4 grams, or about 0.4 grams to about 0.5 grams. In yet another embodiment, the projectile is a shot with a mass of about 0.01 grams to about 1 grams, about 0.05 grams to about 0.8 grams, or about 0.1 grams to about 0.5 grams.

The projectiles of the present disclosure may be particularly useful in calibers where bullets are available in a relatively broad range of standard weights. For example, if in a given caliber the lightest standard weight is approximately half of the heaviest standard weight, the projectiles of the present disclosure may conveniently be used to replace (i.e., used in place of) the lightest standard weight bullet. One example of such a situation is a .308 caliber bullet with standard weights of 110 grains to 220 grains. According to an embodiment, the projectile may be prepared to be .308 caliber in size (having a diameter of 0.308 inches), having the same shape and size as the standard 220 grain bullet but a mass of 110 grains (about 7.1 grams). Among other benefits that may be gained from the construction according to the present disclosure, this may also avoid internal ballistic issues, such as pressure spikes.

In one embodiment, the projectile is a shot, and a plurality of shot may be encased in a shell, such as a shot-gun shell.

The projectile may be constructed to be mechanically propelled by compressed gas. According to some embodiments, the object is a frangible projectile. A frangible projectile disintegrates into small particles upon impact. Preferably, the projectile or large portions of the projectile do not ricochet off of the impact surface. The disintegration of the projectile may be caused by brittle failure of the projectile on impact. Without wishing to be bound by theory, it is hypothesized that using porous metal powder and a powder coat material as a binder, compressing at a low pressure and only briefly heating the object at a relatively low temperature after molding contributes to the density of the object that is suitable for use as a projectile in an air gun, and to the frangibility of the projectile. The low-pressure compression and brief heating may be sufficient to provide cohesion and increased density, while at the same time providing a frangible object that breaks upon impact.

According to an embodiment, the object is a projectile including a first metal powder having a first particle size, a second metal powder having a second particle size, and a polymer binder. The projectile may have a density of about 1.0 g/cm³ to about 4.0 g/cm³, about 2.0 g/cm³ to about 3.9 g/cm³, about 2.8 g/cm³ to about 3.8 g/cm³, about 3.0 g/cm³ to about 3.5 g/cm³, or about 3.1 g/cm³ to about 3.3 g/cm³. The polymer binder may include any suitable polymers, such as thermoset plastics, thermoplastics, or combinations thereof. In some embodiments, the polymer binder includes polyesters, polyurethanes, epoxies, polyacrylates, polycarbonates, and mixtures and composites thereof. The polymer binder may be prepared from a dry powder coat. In one embodiment, the polymer binder includes polyurethane. The polymer binder may also include other components, such as cross linkers, catalysts, fillers, pigments, colorants, opacifiers, visibility aids, and other additives Examples of visibility aids include fluorescent and phosphorescent compounds.

### Example

Molded projectiles were prepared from two iron powders and a dry polymeric powder coating material. The projectiles were molded using a tablet press. The projectiles were pressed using 150-300 psi (estimated) pressure at room temperature. The pressed projectiles were heated at a temperature of 350° F. (about 177° C.) for about 1 minute.

First iron powder was commercially obtained iron 12. The sieve analysis of the iron 12 powder is shown in TABLE 1 below. In the sieve analysis, a number preceded by “+” indicates the fraction remaining on top of the sieve of that mesh size, and a number preceded by “−” indicates the fraction having gone through a sieve of that mesh size. For example, −20/+60 indicates the fraction that has gone through a 20-mesh sieve but not a 60-mesh sieve.

TABLE 1
Sieve analysis of iron 12 powder

| Sieve size (mesh) | Sieve opening (mm) | Wt-% |
|---|---|---|
| +20 | 0.841 | 0-2 |
| −20/+60 | 0.841-0.250 | 30-70 |
| −60/+100 | 0.250-0.149 | 10-35 |
| −325 | 0.044 | 12 |

Second iron powder was commercially obtained iron 100. The sieve analysis of the iron 100 powder is shown in TABLE 2 below.

TABLE 2
Sieve analysis of iron 100 powder

| Sieve size (mesh) | Sieve opening (mm) | Wt-% |
|---|---|---|
| +80 | 0.177 | Trace |
| −80/+100 | 0.177-0.149 | 0.8 |
| −100/+140 | 0.149-0.105 | 14.6 |
| −140/+200 | 0.105-0.074 | 25.8 |
| −200/+325 | 0.074-0.044 | 30.3 |
| −325 | 0.044 | 28.5 |

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A method for making an object, the method comprising:
preparing a premixture of a first metal powder having a first particle size, a second metal powder having a second particle size, and a polymer binder;
compressing the premixture in a mold at a pressure of about 75 psi to about 500 psi and a temperature of about 15° C. to about 40° C. to form a preform; and
heating the preform at a temperature of about 100° C. to about 250° C. for about 0.5 minutes to about 30 minutes.

2. The method of claim 1, wherein the polymer binder comprises a dry powder coat.

3. The method of claim 1, wherein the polymer binder comprises polyurethane.

4. The method of claim 1, wherein the premixture is substantially free of solvents.

5. The method of claim 1, wherein the pressure during compressing is from about 100 psi to about 150 psi.

6. The method of claim 1, wherein the heating is done at about 150° C. to about 200° C. for about 0.5 minutes to about 3 minutes.

7. The method of claim 1, wherein the object has a density of about 2 to about 4 g/cm³.

8. The method of claim 1, wherein the object is a projectile comprising a pellet having a mass of about 0.2 grams to about 0.4 grams.

9. The method of claim 1, wherein the object is a projectile comprising a shot.

10. The method of claim 1, wherein the object is a projectile constructed to be mechanically propelled by compressed gas.

11. The method of claim 1, wherein at least one of the first and second metal powders is a sponge iron powder.

12. The method of claim 1, wherein the first metal powder and the second metal powder are present in the object at a weight ratio of about 6:4 to about 0.1:9.9.

13. (canceled)

14. (canceled)

15. The method of claim 1, wherein the premixture comprises about 88 wt-% to about 93 wt-% of the first and second metal powders combined.

16. The method of claim 1, wherein the premixture comprises about 7 wt-% to about 12 wt-% of the polymer binder.

17. The method of claim 1, wherein combined first and second metal powders and the polymer binder are present in the object at a weight ratio of about 9.2:0.8 to about 8.95:1:05.

18. (canceled)

19. The method of claim 1, wherein the method further comprises tumbling a plurality of objects in a tumbler.

20. The method of claim 1, wherein the premixture comprises an additive comprising one or more of a pigment, a fluorescent agent, a phosphorescent agent, a lubricant, a sealant, or a processing aid.

21-23. (canceled)

24. A projectile comprising:
a first metal powder having a first particle size;
a second metal powder having a second particle size; and
a polymer binder;
the projectile having a density between 1 and 3.5 g/cm³.

25-31. (canceled)

32. The projectile of claim 24, wherein the first metal powder and the second metal powder are present at a weight ratio of about 6:4 to about 4:6.

33-50. (canceled)

51. The method of claim 1 further comprising a finishing step, the finishing step comprising one or more of applying a coating and modifying the surface by machining, rolling, sanding, or tumbling in a tumbler.

52. (canceled)

53. (canceled)
